(19) United States
(12) Patent Application Publication
(10) Pub. No.: US 2014/0209196 A1
(43) Pub. Date: Jul. 31, 2014

(54) Device to Actuate a Quick Trip Valve

(71) Applicant: Voith Patent GmbH, Heidenheim (DE)

(72) Inventor: Armin Goll, Mulfingen (DE)

(73) Assignee: Voith Patent GmbH, Heidenheim (DE)

(21) Appl. No.: 14/161,545

(22) Filed: Jan. 22, 2014

(30) Foreign Application Priority Data
Jan. 31, 2013 (DE) 10 2013 001 658.4
Mar. 8, 2013 (DE) 10 2013 003 976.2

(51) Int. Cl. F16K 31/06

(52) U.S. Cl. CPC F16K 31/06
USPC 137/637

(57) ABSTRACT

The invention concerns a device for operating a trip valve, comprising the following components or characteristics: a number of two-way slide valves, an equal number of springs for prestressing the valve pistons into a non-activated position, an equal number of cylindrical guides for guiding the valve pistons, a switching magnet is associated with every two-way slide valve, two ways and a bypass of a pipe system are connected to each valve, the pipe system exhibits an inlet and an outlet for a hydraulic fluid, which is under pressure when the trip valve is open, the valve pistons are identical to each other as regards their geometrical configuration, the cylindrical guides are respectively arranged in individual casings or in an overall casing, the ways of the hydraulic fluid are situated outside the individual casing or of the overall casing.

The invention concerns a device for operating a trip valve. Such devices are utilised for instance with gas and steam turbines. They provide a reliable protection for all types of power and work machines, for instance for turbo machines. They are indispensable with gas and steam turbines. To do so, it is necessary to detect an overspeed reliably and as a reaction to bring a trip valve immediately into the closed position. It is moreover quite important to avoid false trippings. These trippings may cause undesired standstills. Consequently, the protective function is not provided reliably.

Numerous devices of the type mentioned above are known. See EP 2 074 488 BI. The device described there includes three valve cylinders with valve pistons, three electrical magnetic actuators for moving the valve pistons in opposition to the prestressing of springs, three separate ways, which run between an inlet opening and an outlet opening. To do so, the valve cylinders, the valve pistons and the springs are contained in a single valve block. The ways are situated inside the valve block. Every way intersects three valve cylinders.

A shortcoming of this form of embodiment previously known consists in that the valve pistons have different sizes. Thus, the efficient parts of a first valve piston, i.e. the parts which block or release a fluid passageway, are designed differently from the efficient parts of a second or of a third valve piston. The manufacture and the storage of spare parts are demanding and hence expensive.

The object of the invention is to improve such a device. It must be easier to build, function more reliably and be constructed more cheaply.

This object is met by the features of claim 1.

Unlike the publication first mentioned, the device according to the invention only includes two ways per valve cylinder. The path ways are not internal ways of an individual valve block.

The basic idea of the invention hence lies in arranging the cylindrical guides as well as the piston devices contained therein also in their own casing, possibly also together in a common casing. However, the ways of the hydraulic fluid are arranged outside the individual casing or the overall casing. We have conscientiously refused to arrange the cylindrical guides, the piston devices as well as the fluid ways in a single block.

The resulting major advantage consists in the possibility of designing completely identically all the piston devices. They have absolutely the same configuration and the same sizes. This relates to the efficient parts of the individual piston device as well.

The fluid ways are situated outside of the individual casing. They can be arranged in a second casing, for example in the form of bores in the second casing. Pipes for the production of a guiding connection between the individual casing or overall casing with the piston devices and the second casing can be provided.

The invention is described below with reference to the drawing. The following details are shown:

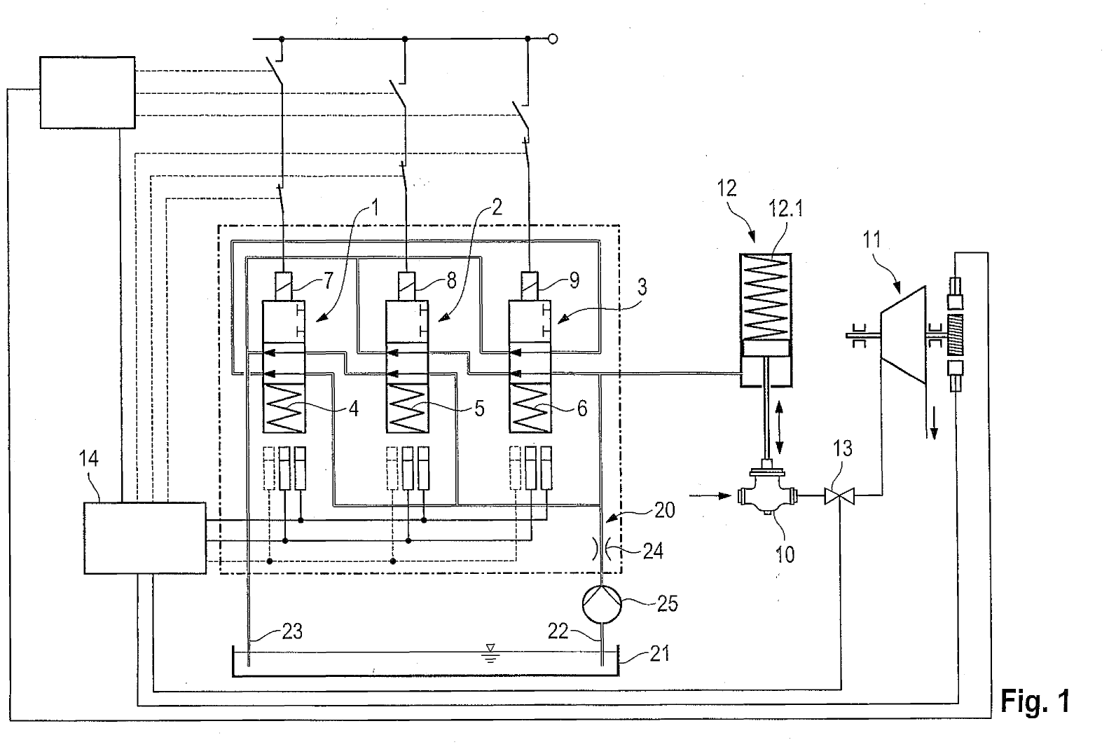

FIG. 1 is a flowchart of a device with trip valve and steam turbine.

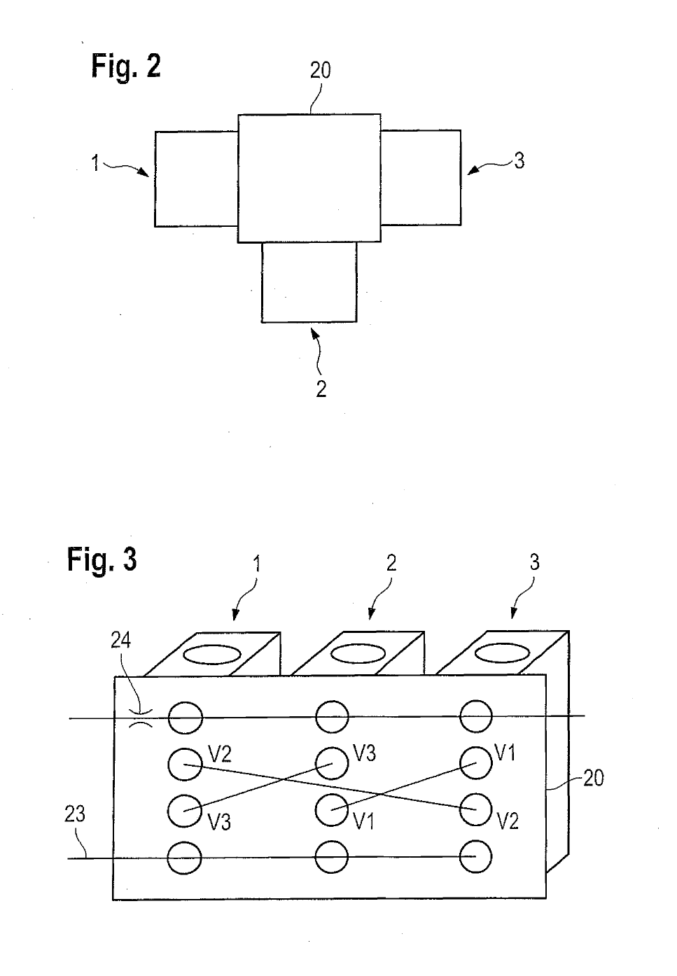

FIG. 2 is a top view on the device in a cubic arrangement.

FIG. 3 is a perspective representation of the device in a parallel arrangement.

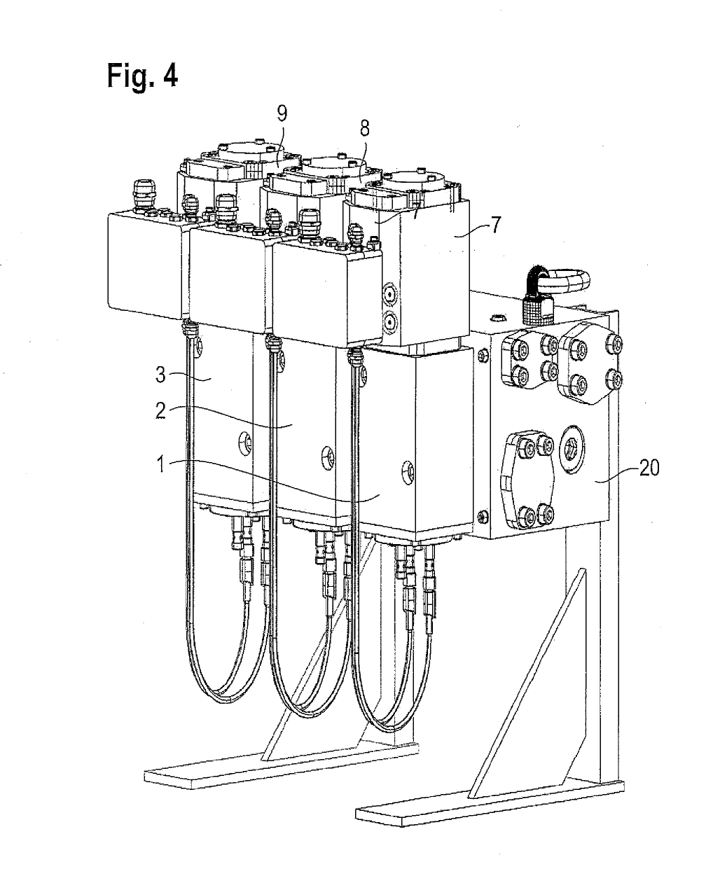

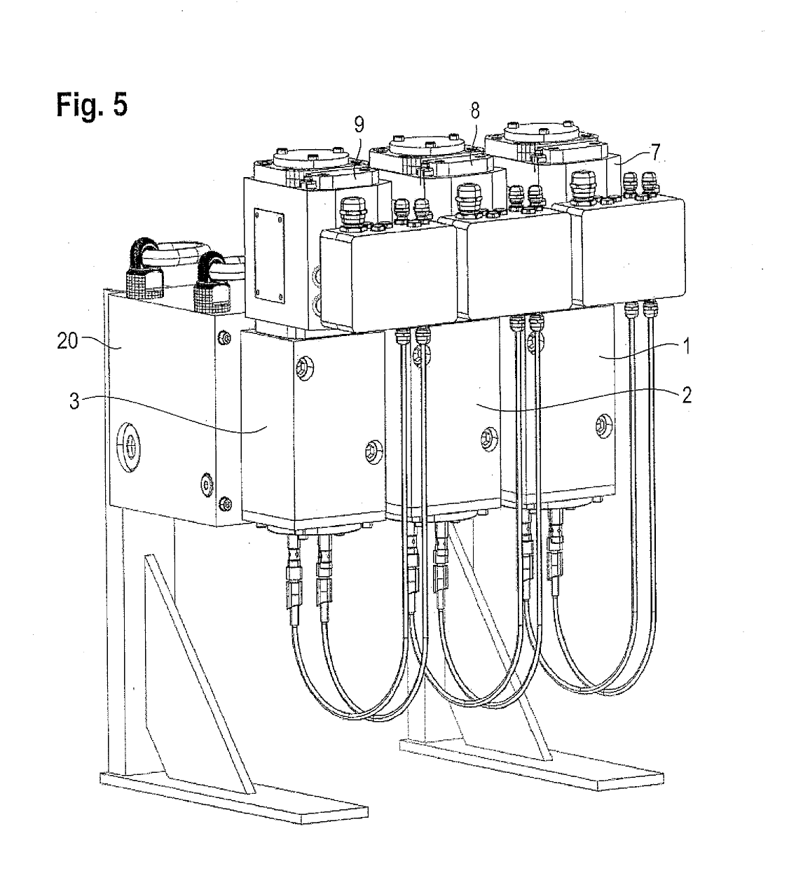

FIGS. 4 and 5 are perspective representations of a device.

The flowchart illustrated on FIG. 1 shows the following in detail:

The device according to the invention includes three two-way slide valves 1, 2, 3. Every slide valve knowingly contains a valve cylinder and a valve piston which is slidable therein.

A spring 4, 5, 6 is associated with each valve piston. The springs maintain the valve pistons in an open position in the illustrated exemplary embodiment. See the arrows, which are respectively arranged in pairs and the oil ways through the valves are illustrated.

The figure shows moreover three switching magnets (magnetic actuators) 7, 8, 9. A switching magnet is respectively associated with a valve.

The installation includes a trip valve 10. Said valve is switched between the device according to the invention and a steam turbine 11.

A hydraulic actuator 12 is associated to the trip valve 10. Said actuator includes a piston-cylinder unit as a closing spring 12.1.

A regulating valve 13 is connected between the trip valve 10 and the turbine 11.

A turbine-regulating system 14 is represented schematically.

The installation includes a hydraulic pipe system 20, which contains a liquid, oil in the present case. It contains individually the following components: an oil storage tank 21 with an inlet 22 for withdrawing oil with the hydraulic pump 25 from the storage tank 21 and an outlet 23 for returning oil into the storage tank 21 and an adjustable throttle 24.

The three valves 1, 2, 3 are in an open position in the form of embodiment represented. The valves are three 4/2-way-slide valves. A switching magnet actuates respectively the valves. The three slide valves are connected in series. A controlled shutdown of the trip valve 10 only takes place when switching off at least two switching magnets. The shutdown cross-section of the valves is selected with respect to the opening cross-section of the throttle 24 in such a way that the inflow quantity via the throttle 24 does not influence essentially the closing behaviour of the actuator 12. It means a choice of 2 out of 3 during the hydraulic controlled shutdown of the trip valve.

With the configuration according FIG. 2 represented schematically, the hydraulic pipe system 20 is represented as a centrally arranged hydraulic block, surrounded by the three valves 1, 2 and 3. A spring as well as a switching magnet are associated with every valve, as described above with reference to FIG. 1.

In the configuration according to FIG. 3, the three slide valves 1, 2 and 3 (again together with the springs, but without the switching magnets 7, 8 and 9) are arranged in parallel, that is to say in a row. The hydraulic pipe system 20 is again connected to all the three slide valves 1, 2 and 3. The piping options V1, V2, V3 are illustrated through connection lines. The simplicity of the necessary piping connections, which are shuffled in the hydraulic blocks, can be seen clearly, see FIGS. 2, 4 and 5.

The device shown in FIGS. 4 and 5 again contains the three slide valves 1, 2, 3 with the switching magnets 7, 8, 9. A spring is respectively associated with the slide valves, not recognisable here. Every valve slide with its accessories is situated in its own respective casing which has the same design. But the three valve slides could also be arranged in a single overall casing.

The hydraulic pipe system 20 is arranged in a single block or casing 20. To do so, the three individual casings and the casing of the hydraulic pipe system 20 are connected to one another directly and in contact. There is hence no gap between the casings of the valve slides 1, 2, 3 and the casing of the hydraulic pipe system 20, so that pipes are not laying freely between both of them or that no pipes are necessary.

### LIST OF REFERENCE SIGNS

1 Two-way slide valve
2 Two-way slide valve
3 Two-way slide valve
4 Spring
5 Spring
6 Spring
7 Switching magnet
8 Switching magnet
9 Switching magnet
10 Trip valve
11 Turbine
12 Actuator
12.1 Closing spring
13 Regulating valve
14 Turbine-regulating system
20 Hydraulic pipe system
21 Oil storage tank
22 Inlet
23 Outlet
24 Throttle

1-5. (canceled)

6. A device for operating a trip valve, the device comprising:
a plurality of two-way slide valves;
an equal number of springs for prestressing the valve pistons into a non-activated position;
an equal number of cylindrical guides for guiding the valve pistons;
a switching magnet is associated with every two-way slide valve; and
two ways and a bypass of a pipe system are connected to each valve;
wherein:
the pipe system exhibits an inlet and an outlet for a hydraulic fluid, which is under pressure when the trip valve is open;
the valve pistons are identical to each other as regards their geometrical configuration;
the cylindrical guides are respectively arranged in individual casings or in a common casing;
the path ways of the hydraulic fluid are situated outside the individual casing or of the common casing.

7. The device according to claim 6, wherein respectively one valve is arranged in its own valve block or that all valves are arranged in a common valve block.

8. The device according to claim 6, wherein the path ways of the hydraulic fluid are formed between the valves from pipings, which are situated outside the valve block respectively the valve blocks.

9. The device according to claim 7, wherein the path ways of the hydraulic fluid are formed between the valves from pipings, which are situated outside the valve block respectively the valve blocks.

10. The device according to claim 6, wherein several valve blocks are sealingly located close to each other free of pipelines.

11. The device according to claim 7, wherein several valve blocks are sealingly located close to each other free of pipelines.

12. The device according to claim 8, wherein several valve blocks are sealingly located close to each other free of pipelines.

13. The device according to claim 9, wherein several valve blocks are sealingly located close to each other free of pipelines.

14. The device according to claim 6, wherein three two-way slide valves are provided.

15. The device according to claim 7, wherein three two-way slide valves are provided.

16. The device according to claim 8, wherein three two-way slide valves are provided.

17. The device according to claim 9, wherein three two-way slide valves are provided.

18. The device according to claim 10, wherein three two-way slide valves are provided.

19. The device according to claim 11, wherein three two-way slide valves are provided.

20. The device according to claim 12, wherein three two-way slide valves are provided.

21. The device according to claim 13, wherein three two-way slide valves are provided.
